(19) United States
(12) Patent Application Publication
(10) Pub. No.: US 2019/0034354 A1
(43) Pub. Date: Jan. 31, 2019

(54) FILTERING INSERTION OF EVICTED CACHE ENTRIES PREDICTED AS DEAD-ON-ARRIVAL (DOA) INTO A LAST LEVEL CACHE (LLC) MEMORY OF A CACHE MEMORY SYSTEM

(71) Applicant: QUALCOMM Incorporated, San Diego, CA (US)

(72) Inventor: Shivam Priyadarshi, Morrisville, NC (US)

(21) Appl. No.: 15/660,006

(22) Filed: Jul. 26, 2017

(51) Int. Cl. G06F 12/128; G06F 12/0811; G06F 12/122

(52) U.S. Cl. CPC G06F 12/128; G06F 12/0811; G06F 2212/621; G06F 2212/283; G06F 12/122

(57) ABSTRACT

Filtering insertion of evicted cache entries predicted as dead-on-arrival (DOA) into a last level cache (LLC) memory is disclosed. A lower-level cache memory updates a DOA prediction value associated with a requested cache entry in a DOA prediction circuit indicating a cache entry reuse history. The DOA prediction value is updated to indicate if the requested cache entry was reused in the LLC memory or not based on whether a cache miss in the lower-level cache memory for the requested cache entry was serviced by the LLC memory. Subsequently, upon eviction of the requested cache entry from the lower-level cache memory, the associated DOA prediction value can be consulted to predict if the cache entry will be DOA. If so, the LLC memory is filtered to store the evicted cache entry in system memory or to insert in a less recently used location in the LLC memory.

### BACKGROUND

### I. Field of the Disclosure

The technology of the disclosure relates generally to cache memory systems provided in computer systems, and more particularly to accesses and evictions between lower-level cache memories and last level cache (LLC) memories in cache memory systems.

### II. Background

A memory cell is a basic building block of computer data storage, which is also known as “memory.” A computer system may either read data from or write data to memory. Memory can be used to provide cache memory in a central processing unit (CPU) system as an example. Cache memory, which can also be referred to as just a “cache,” is a smaller, faster memory that stores copies of data stored at frequently accessed memory addresses in main memory or higher level cache memory to reduce memory access latency. Thus, a cache memory can be used by a CPU to reduce memory access times. For example, a cache may be used to store instructions fetched by a CPU for faster instruction execution. As another example, a cache may be used to store data to be fetched by a CPU for faster data access.

A cache memory is comprised of a tag array and a data array. The tag array contains addresses also known as “tags.” The tags provide indexes into data storage locations in the data array. A tag in the tag array and data stored at an index of the tag in the data array is also known as a “cache line” or “cache entry.” If a memory address or portion thereof provided as an index to the cache as part of a memory access request matches a tag in the tag array, this is known as a “cache hit.” A cache hit means that the data in the data array contained at the index of the matching tag contains data corresponding to the requested memory address in main memory and/or a lower-level cache. The data contained in the data array at the index of the matching tag can be used for the memory access request, as opposed to having to access main memory or a higher level cache memory having greater memory access latency. If however, the index for the memory access request does not match a tag in the tag array, or if the cache line is otherwise invalid, this is known as a “cache miss.” In a cache miss, the data array is deemed not to contain data that can satisfy the memory access request. A cache miss will trigger an inquiry to determine if the data for the memory address is contained in a higher level cache memory. If all caches miss, the data will be accessed from a system memory, such as a dynamic random access memory (DRAM).

A multi-level cache memory system that includes multiple levels of cache memory can be provided in a CPU system. Multi-level cache memory systems can either be an inclusive or exclusive last level cache (LLC). If a cache memory system is an inclusive LLC, a copy of a cached data entry in a lower-level cache memory is also contained in the LLC memory. AN LLC memory is a cache memory that is accessed before accessing system or main memory. However, if a cache memory system is an exclusive LLC, a cached data entry stored in a lower-level cache memory is not stored in the LLC memory to maintain exclusivity between the lower-level cache memory and the LLC memory. Exclusive LLCs have been adopted over inclusive LLCs, because of the capacity advantage gained by not replicating cached data entries in multiple levels of the cache hierarchy. Exclusive LLCs can also exhibit a significant performance advantage over inclusive LLCs, because in an inclusive LLC, an eviction from an LLC memory based on its replacement policy forces eviction of that cache line from inner-level cache memories without knowing if the cache line will be reused. However, an exclusive LLC can have performance disadvantages over an inclusive LLC. In an exclusive LLC, and unlike an inclusive LLC, on a cache hit to the LLC memory resulting from a request from a lower-level cache memory, the accessed cache line in the LLC memory is deallocated from the LLC memory to maintain exclusivity.

In either case of an inclusive or exclusive LLC, if an installed cache line in an LLC memory is not reused before the cache line is evicted from the LLC memory, the cache line is “dead.” A “dead” cache line is a cache line that was installed in and evicted from a cache memory before the cache line was reused. A “dead” cache line may occur, for example, for streaming applications where the same memory locations are not re-accessed, or when a particular memory location is not re-accessed frequently such that the cache entry for the memory location is evicted before reuse. Thus, “dead” cache lines in any LLC memory incur the overhead of installing the cache line due to the eviction from the lower-level cache for a one time installment of a cache line. Dead cache lines installed in an LLC memory consume space for no additional benefit of reuse.

### SUMMARY OF THE DISCLOSURE

Aspects disclosed herein include filtering insertion of evicted cache entries predicted as dead-on-arrival (DOA) into a last level cache (LLC) memory of a cache memory system. A DOA cache entry is a cache entry (i.e., a cache line) that is installed and evicted from a cache memory before the cache entry is reused. DOA cache entries waste space in a cache memory without obtaining the benefit of reuse. A lower-level cache memory accesses an LLC memory for a requested cache entry in response to a cache miss to the lower-level cache memory. If a cache hit for the requested cache entry occurs in LLC memory, the cache entry is supplied by the LLC memory, meaning the cache entry was reused before being evicted from the LLC memory. However, if a cache miss for the requested cache entry occurs in LLC memory, the cache entry is supplied by the system memory, meaning the cache entry was not reused before it was evicted from the LLC memory.

In exemplary aspects disclosed herein, the lower-level cache memory is configured to update a DOA prediction value associated with the requested cache entry in a DOA prediction circuit indicating a reuse history of the cache entry. If the requested cache entry was serviced by the system memory as a result of the cache miss to the lower-level cache memory, the DOA prediction value is updated to indicate the requested cache entry was not reused. If the requested cache entry was serviced by the LLC memory as a result of the cache miss to the lower-level cache memory, the DOA prediction value is updated to indicate that the cache entry was reused in the LLC memory. Thus, subsequently upon an eviction of the requested cache entry from the lower-level cache memory, the DOA prediction value in the DOA prediction circuit associated with the evicted cache entry can be consulted to predict if the cache entry will be DOA. In certain aspects disclosed herein, if the evicted cache entry is predicted to be DOA, the LLC memory is filtered and more specifically bypassed, and the evicted cache entry is evicted to system memory if dirty (and silently evicted if clean) to avoid wasting space in the LLC memory for a predicted DOA cache entry. Bypassing insertion of the evicted cache entry from the LLC memory can avoid the overhead of installing the evicted cache entry in the LLC memory. In other aspects disclosed herein, if the evicted cache entry is predicted to be DOA, the LLC memory is filtered to install the evicted cache entry in a less recently used cache entry in the LLC memory to reduce or avoid evicting a more recently used cache entry.

Providing the DOA prediction circuit to predict whether an evicted lower-level cache entry is DOA in the LLC memory may be particularly advantageous for exclusive LLCs. This is because in an exclusive LLC, a cache entry in the LLC memory gets de-allocated on its first reuse of the cache entry (i.e., a cache hit) to maintain exclusivity. In response to a cache hit to a cache entry in an exclusive LLC memory, the cache entry is de-allocated from the LLC memory and installed in the lower-level cache memory. This leaves no reuse history in the LLC memory to consult to determine that the cache entry was reused. The aspects disclosed herein can be employed to provide for the DOA prediction circuit to maintain reuse history of cache entries in an exclusive LLC memory so that this reuse history can be consulted to determine if the LLC memory should be filtered for an evicted lower-level cache entry.

In this regard, in one exemplary aspect, a cache memory system is provided. The cache memory system comprises a lower-level cache memory configured to store a plurality of lower-level cache entries each representing a system data entry in a system memory. The lower-level cache memory is configured to evict a lower-level cache entry among the plurality of lower-level cache entries to an LLC memory. The lower-level cache memory is also configured receive a last level cache entry from the LLC memory in response to a cache miss to a lower-level cache. The cache memory system also comprises the LLC memory configured to store a plurality of last level cache entries each representing a data entry in a system memory. The LLC memory is configured to insert the evicted lower-level cache entry from the lower-level cache memory in a last level cache entry among the plurality of lower-level cache entries based on the address of the evicted lower-level cache entry. The LLC memory is also configured to evict a last level cache entry to the system memory. The LLC memory is also configured to receive a system data entry from the system memory in response to a cache miss to the LLC memory. The cache memory system also comprises a DOA prediction circuit comprising one or more DOA prediction registers associated with the plurality lower-level cache entries each configured to store a DOA prediction value indicative of a whether the plurality lower-level cache entries are predicted to be dead from the LLC memory. The lower-level cache memory is configured to evict a lower-level cache entry to the LLC memory. In response to eviction of the lower-level cache entry from the lower-level cache memory, the cache memory system is configured to, access a DOA prediction value in a DOA prediction register among the one or more DOA prediction registers associated with the evicted lower-level cache entry, and determine if the evicted lower-level cache entry is predicted to be dead from the LLC memory based on the accessed DOA prediction value, and in response to determining the evicted lower-level cache entry is predicted to be dead from the LLC memory, filter the evicted lower-level cache entry in the LLC memory

In another exemplary aspect, a method of evicting a lower-level cache entry in a cache memory system is provided. The method comprises evicting a lower-level cache entry among the plurality of lower-level cache entries from a lower-level cache memory to an LLC memory. The method also comprises accessing a DOA prediction value in a DOA prediction register among the one or more DOA prediction registers associated with the evicted lower-level cache entry. The method also comprises determining if the evicted lower-level cache entry is predicted to be dead from the LLC memory based on the accessed DOA prediction value. In response to determining the evicted lower-level cache entry is predicted to be dead from the LLC memory, the method also comprises filtering the evicted lower-level cache entry in the LLC memory.

In another exemplary aspect, an LLC memory is provided. The LLC memory comprises a last level cache configured to store a plurality of last level cache entries each representing a data entry in a system memory. The LLC memory also comprises an LLC controller. The LLC controller is configured to receive an evicted lower-level cache entry from a lower-level cache memory. The LLC controller is also configured to insert the received evicted lower-level cache entry in a last level cache entry among the plurality of lower-level cache entries based on the address of the evicted lower-level cache entry. The LLC controller is configured to evict a last level cache entry to the system memory. The LLC controller is also configured to receive a system data entry from the system memory in response to a cache miss to the LLC memory. In response to the received evicted lower-level cache memory from the lower-level cache entry, the LLC controller is configured to access a DOA prediction value in a DOA prediction register among the one or more DOA prediction registers associated with the evicted lower-level cache entry, determine if the evicted lower-level cache entry is predicted to be dead from the LLC memory based on the accessed DOA prediction value, and in response to determining the evicted lower-level cache entry is predicted to be dead from the LLC memory, filter the evicted lower-level cache entry in the last level cache entry among the plurality of lower-level cache entries.

In another exemplary aspect, a lower-level cache memory is provided. The lower-level cache memory comprises a lower-level cache comprising a plurality of lower-level cache entries each representing a system data entry in a system memory. the lower-level cache memory also comprises a lower-level cache controller. The lower-level cache controller is configured to evict a lower-level cache entry among the plurality of lower-level cache entries to a last level cache (LLC) memory. The lower-level cache controller is also configured to receive a last level cache entry from the LLC memory in response to a cache miss to a lower-level cache. The lower-level cache controller is also configured to receive a request to access a lower-level cache entry among the plurality of lower-level cache entries in the lower-level cache. The lower-level cache controller is also configured to generate a lower-level cache miss in response to the requested lower-level cache entry not being present in the lower-level cache memory. In response to the lower-level cache miss, the lower-level cache controller is configured to determine if the received data entry associated with the memory address of the requested lower-level cache entry was serviced by a system memory, and update a DOA prediction value in a DOA prediction register among one or more DOA prediction registers associated with the requested lower-level cache entry based on the determination of the whether the received data entry was serviced by the system memory.

### BRIEF DESCRIPTION OF THE FIGURES

FIG. 1 is a block diagram of an exemplary processor system that includes a plurality of central processing units (CPUs) and a memory system that includes a cache memory system including a hierarchy of local and shared cache memories, including a last level cache (LLC) memory and a system memory;

FIG. 2 is a graph illustrating an exemplary memory miss service profile indicating if a cache miss for a requested cache entry in a lower-level cache memory in the cache memory system of FIG. 1 was serviced by the LLC memory or the system memory, as a function of a memory region for the requested cache entry;

FIG. 3 is a block diagram of an exemplary cache memory system that can be provided in the processor system in FIG. 1, wherein the cache memory system is configured to update a dead-on-arrival (DOA) prediction circuit indicating whether lower-level cache entries evicted from the lower-level cache memory are predicted to be DOA in the LLC memory, and filter insertion of the evicted lower-level cache entries predicted as DOA in the LLC memory;

FIG. 4 is a flowchart illustrating an exemplary process of consulting a DOA prediction value in the DOA prediction circuit in FIG. 3 in response to eviction of a cache entry from the lower-level cache memory in the cache memory system to predict if the evicted cache entry is DOA, and determine if the LLC memory should be filtered out for insertion of the evicted cache entry;

FIG. 5 is a flowchart illustrating an exemplary process of updating a DOA prediction value associated with a requested cache entry in the DOA prediction circuit in FIG. 3, in response to a cache miss in a lower-level cache memory in the cache memory system;

FIG. 6 is a block diagram of an exemplary DOA prediction circuit that can be employed in the cache memory system of FIG. 3 to store DOA prediction values associated with cache entries indicative of whether a cache entry will be reused or not reused and be dead;

FIG. 7A illustrates an exemplary address-based entry inserted into the DOA prediction circuit in FIG. 6 as a result of a cache miss to a lower-level cache memory in the cache memory system in FIG. 3 employing the DOA prediction circuit;

FIG. 7B illustrates an exemplary program counter (PC)-based entry inserted into the DOA prediction circuit in FIG. 6 as a result of a cache miss to a lower-level cache memory in the cache memory system in FIG. 3 employing the DOA prediction circuit;

FIG. 8 is a block diagram of another exemplary tagged DOA prediction circuit that can be employed in the cache memory system of FIG. 3 to store DOA prediction values associated with cache entries indicative of whether a cache entry will be reused or not reused and be dead;

FIG. 9A illustrates an exemplary address-based entry inserted into the tagged DOA prediction circuit in FIG. 8 as a result of a cache miss to a lower-level cache memory in the cache memory system in FIG. 3 employing the tagged DOA prediction circuit;

FIG. 9B illustrates an exemplary PC-based entry inserted into the tagged DOA prediction circuit in FIG. 8 as a result of a cache miss to a lower-level cache memory in the cache memory system in FIG. 3 employing the tagged DOA prediction circuit;

FIG. 10 illustrates an exemplary LLC cache memory that can be included in the cache memory system in FIG. 3 and that includes follower cache sets and dueling dedicated cache sets associated with an evicted cache entry insertion policy, wherein the LLC memory is configured to apply an insertion policy for an evicted cache entry from a lower-level cache memory based on an insertion policy value in an insertion policy circuit updated by the LLC memory based on dueling cache misses to each dedicated cache set in response to a cache miss to the lower-level cache memory; and

FIG. 11 is a block diagram of an exemplary processor-based system that includes a cache memory system configured to filter insertion of evicted cache entries predicted as DOA in an LLC memory.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include filtering insertion of evicted cache entries predicted as dead-on-arrival (DOA) into a last level cache (LLC) memory of a cache memory system. A DOA cache entry is a cache entry (i.e., a cache line) that is installed and evicted from a cache memory before the cache entry is reused. DOA cache entries waste space in a cache memory without obtaining the benefit of reuse. A lower-level cache memory accesses an LLC memory for a requested cache entry in response to a cache miss to the lower-level cache memory. If a cache hit for the requested cache entry occurs in LLC memory, the cache entry is supplied by the LLC memory, meaning the cache entry was reused before being evicted from the LLC memory. However, if a cache miss for the requested cache entry occurs in LLC memory, the cache entry is supplied by the system memory, meaning the cache entry was not reused before it was evicted from the LLC memory.

In exemplary aspects disclosed herein, the lower-level cache memory is configured to update a DOA prediction value associated with the requested cache entry in a DOA prediction circuit indicating a reuse history of the cache entry. If the requested cache entry was serviced by the system memory as a result of the cache miss to the lower-level cache memory, the DOA prediction value is updated to indicate the requested cache entry was not reused. If the requested cache entry was serviced by the LLC memory as a result of the cache miss to the lower-level cache memory, the DOA prediction value is updated to indicate that the cache entry was reused in the LLC memory. Thus, subsequently upon an eviction of the requested cache entry from the lower-level cache memory, the DOA prediction value in the DOA prediction circuit associated with the evicted cache entry can be consulted to predict if the cache entry will be DOA. In certain aspects disclosed herein, if the evicted cache entry is predicted to be DOA, the LLC memory is filtered and more specifically bypassed, and the evicted cache entry is evicted to system memory if dirty (and silently evicted if clean) to avoid wasting space in the LLC memory for a predicted DOA cache entry. Bypassing insertion of the evicted cache entry from the LLC memory can avoid the overhead of installing the evicted cache entry in the LLC memory. In other aspects disclosed herein, if the evicted cache entry is predicted to be DOA, the LLC memory is filtered to install the evicted cache entry in a less recently used cache entry in the LLC memory to reduce or avoid evicting a more recently used cache entry.

Providing the DOA prediction circuit to predict whether an evicted lower-level cache entry is DOA in the LLC memory may be particularly advantageous for exclusive LLCs. This is because in an exclusive LLC, a cache entry in the LLC memory gets de-allocated on its first reuse of the cache entry (i.e., a cache hit) to maintain exclusivity. In response to a cache hit to a cache entry in an exclusive LLC memory, the cache entry is de-allocated from the LLC memory and installed in the lower-level cache memory. This leaves no reuse history in the LLC memory to consult to determine that the cache entry was reused. The aspects disclosed herein can be employed to provide for the DOA prediction circuit to maintain reuse history of cache entries in an exclusive LLC memory so that this reuse history can be consulted to determine if the LLC memory should be filtered for an evicted lower-level cache entry.

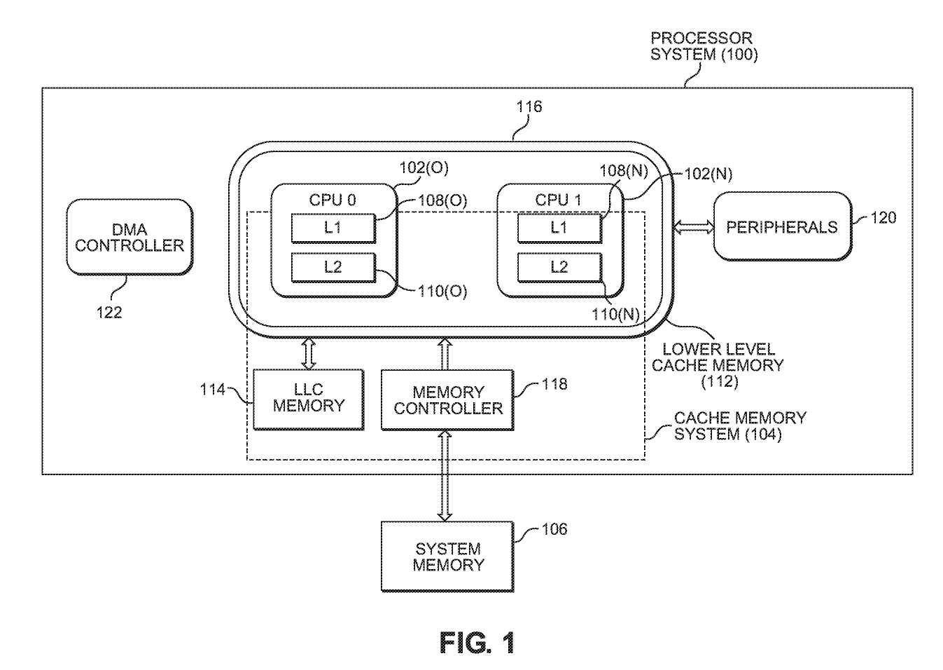

In this regard, FIG. 1 is a block diagram of an exemplary processor system 100 that includes a plurality of central processing units (CPUs) 102(0)-102(N) and a cache memory system 104 for storing cached data entries with data in a system memory 106. In this example, the cache memory system 104 includes a hierarchy of local, private cache memories 108(0)-108(N) on-chip with and accessible only to each respective CPU 102(0)-102(N), local, public cache memories 110(0)-110(N) that form a shared lower-level cache memory 112 accessible to all CPUs 102(0)-102(N), and a LLC memory 114. The LLC memory 114 is the last level of cache memory before a memory access reaches the system memory 106. For example, the system memory 106 may be a dynamic read access memory (DRAM). As examples, the local, private cache memories 108(0)-108(N) may be level 1 (L1) cache memories, the shared lower-level cache memory 112 may be a level 2 (L2) cache memory, and the LLC memory 114 may be a level 3 (L3) cache memory. The LLC memory 114 may be an exclusive LLC memory that maintains exclusivity of cache entries between the LLC memory 114 and the shared lower-level cache memory 112. Alternatively, the LLC memory 114 may be an inclusive LLC memory that allows the same cache entries to be stored in both the LLC memory 114 and the lower-level cache memory 112. An internal system bus 116, which may be a coherent bus, is provided that allows each of the CPUs 102(0)-102(N) to access the LLC memory 114 as well as other shared resources. Other shared resources that can be accessed by the CPUs 102(0)-102(N) through the internal system bus 116 can include a memory controller 118 for accessing the system memory 106, peripherals 120, and a direct memory access (DMA) controller 122.

With continuing reference to FIG. 1, if a data read operation to a local, private cache memory 108(0)-108(N) results in a cache miss, the requesting CPU 102(0)-102(N) provides the data read operation to a next level cache memory, which in this example is a local, public cache memory 110(0)-110(N). If the data read operation then results in a cache miss in the lower-level cache memory 112, the data read operation is forwarded to the LLC memory 114. If the data read operation results in a cache hit in the LLC memory 114, the LLC memory 114 provides the cache entry (e.g., a cache line) associated with a memory address of the data read operation to the lower-level cache memory 112. If the LLC memory 114 is an exclusive LLC memory, the cache entry associated with the memory address of the data read operation in the LLC memory 114 is invalidated to maintain exclusivity of cache entries between the LLC memory 114 and the lower-level cache memory 112. If however, the data read operation results in a cache hit in the LLC memory 114, the data read operation is forwarded to the system memory 106 through the memory controller 118. If the LLC memory 114 is an exclusive LLC memory, the data entry corresponding to the memory address of the data read operation is then forwarded from the memory controller 118 to the lower-level cache memory 112 to maintain exclusivity. If however, the LLC memory 114 is an inclusive LLC memory, the data entry corresponding to the memory address of the data read operation is forwarded from the memory controller 118 to the LLC memory 114, which then also forwards the data entry to the lower-level cache memory 112.

With continuing reference to FIG. 1, in response to a cache miss to the lower-level cache memory 112, the lower-level cache memory 112 evicts a stored cache entry therein to make room for the new cache entry received from the LLC memory 114 or the system memory 106. The lower-level cache memory 112 evicts a stored cache entry therein to the LLC memory 114. The LLC memory 114 may in response evict a stored cache memory in the LLC memory 114 to the system memory 106. In either case of an inclusive or exclusive LLC memory 114, if an installed cache entry in the LLC memory 114 is not reused before the cache entry is evicted from the LLC memory 114, the cache entry is “dead.” A “dead” cache entry is a cache entry that was installed in and evicted from a cache memory before the cache entry was reused. A “dead” cache entry may occur in the LLC memory 114, for example, for streaming applications where the same memory locations are not re-accessed, or when a particular memory location is not re-accessed frequently such that the cache entry for the memory location is evicted from the LLC memory 114 before reuse. Thus, “dead” cache entries in the LLC memory 114 incur the overhead of installing the cache entry due to the eviction from the lower-level cache memory 112 for a one time installment of a cache entry in the LLC memory 114.

With continuing reference to FIG. 1, if a cache miss incurred in the lower-level cache memory 112 is serviced by the LLC memory 114, this means that the cache entry in the LLC memory 114 was reused and thus was not a dead cache entry. If however, a cache miss incurred in the lower-level cache memory 112 is serviced instead by the system memory 106, this is an indication that the LLC memory 114 incurred a cache miss. Thus, if the lower-level cache memory 112 evicts a cache entry to the LLC memory 114 that ends up being a dead cache entry (i.e., is not reused before being de-allocated from the LLC memory 114), the dead cache entry is unnecessarily consuming space in the LLC memory 114 leading to cache pollution. Further, when the dead cache entry is allocated in the LLC memory 114, overhead is incurred in another cache entry in the LLC memory 114 being de-allocated to the system memory 106 to make room for the dead cache entry, thus leading to inefficiencies in the performance in the cache memory system 104. Thus, in aspects disclosed herein, by predicting if the evicted cache entry from the lower-level cache memory 112 will be reused, or not and thus dead in the LLC memory 114, this information can be used to determine if the evicted cache entry should be filtered for installation in the LLC memory 114. For example, if the evicted cache entry is predicted to be DOA, the LLC memory 114 could be bypassed where the evicted cache entry is installed in the system memory 106 to avoid consuming space in the LLC memory 114 for dead cache entries.

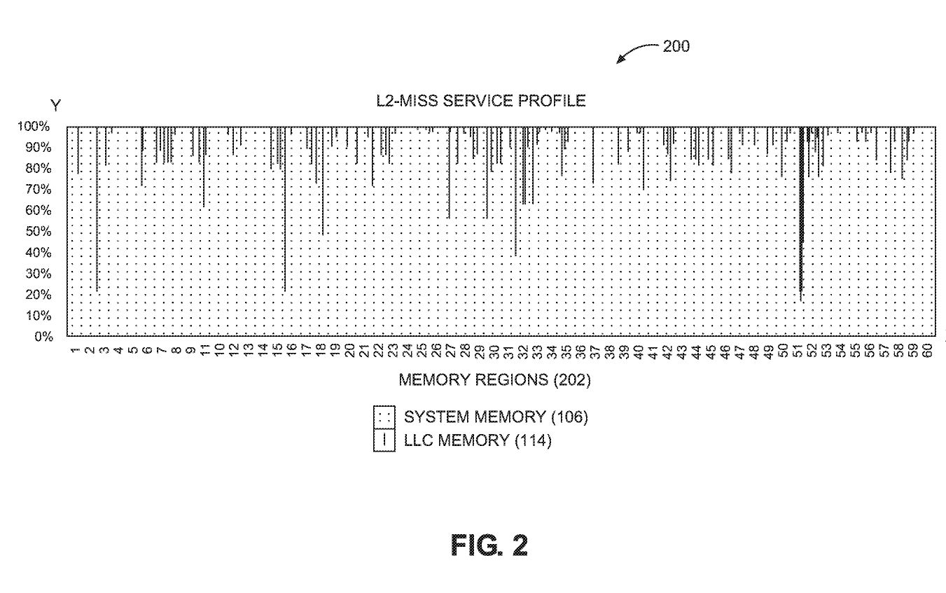

Further, being able to predict whether a cache entry from the lower-level cache memory 112 is DOA in the LLC memory 114 may be particularly advantageous for exclusive LLCs. This is because if the LLC memory 114 is an exclusive LLC, a cache entry in the LLC memory 114 gets de-allocated on its first reuse of the cache entry (i.e., a cache hit) to maintain exclusivity with the lower-level cache memory 112. This leaves no reuse history in the LLC memory 114 to consult to determine that the cache entry in the LLC memory 114 was reused to predict if the cache entry is DOA. However, it can be observed statistically how often memory regions of the processor system 100 in FIG. 1 are serviced by the LLC memory 114 versus the system memory 106 in response to cache miss to the lower-level cache memory 112. In this regard, FIG. 2 is a graph 200 illustrating an exemplary miss service profile in the lower-level cache memory 112 indicating if a cache miss for a requested cache entry was serviced by the LLC memory 114 or the system memory 106. The miss service profile is graphed according to memory regions 202 on the X-axis and the percentage split of servicing the cache miss between the LLC memory 114 or the system memory 106 for each memory region 202 on the Y-axis. As shown therein, certain memory regions 202 are dominantly serviced by the LLC memory 114, such as memory regions 3 and 16 for example. On the other hand, other memory regions 202 are dominantly serviced by the system memory 106, such as memory regions 1 and 12 for example. This miss service profile can be used to predict if an evicted cache entry from the lower-level cache memory 112 will be DOA if installed in the LLC memory 114.

Thus, as discussed in more detail below, in aspects disclosed herein, upon an eviction of the requested cache entry from the lower-level cache memory 112 in the processor system 100 in FIG. 1, the evicted cache entry can be predicted as being DOA or not. In certain aspects disclosed herein, if the evicted cache entry is predicted to be DOA, the LLC memory 114 is filtered and more specifically bypassed, and the evicted cache entry is evicted to the system memory 106 if dirty (and silently evicted if clean) to avoid wasting space in the LLC memory 114 for a predicted DOA cache entry. Bypassing insertion of the evicted cache entry from the LLC memory 114 can avoid the overhead of installing the evicted cache entry in the LLC memory 114. In other aspects disclosed herein, if the evicted cache entry is predicted to be DOA, the LLC memory 114 is filtered to install the evicted cache entry in a less recently used cache entry in the LLC memory 114 to avoid evicting a more recently used cache entry. Avoiding evicting a more recently used cache entry in the LLC memory 114 can improve efficiency of the cache memory system 104 as opposed to evicting a less or least recently used cache entry.

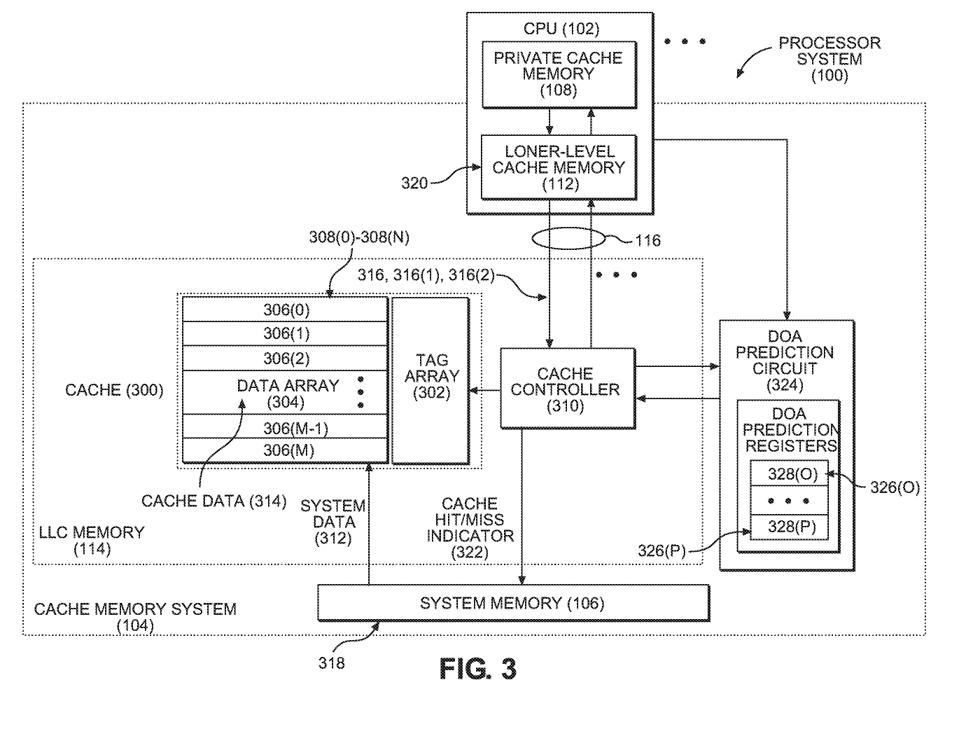

In this regard, FIG. 3 is a block diagram of a more detailed example of the cache memory system 104 that can be provided in the processor system 100 in FIG. 1. As will discussed in more detail below, the cache memory system 104 in FIG. 3 is configured to filter insertion of the evicted lower-level cache entries from the lower-level cache memory 112 predicted as DOA in the LLC memory 114. In this regard, the LLC memory 114 in FIG. 1 includes a cache 300. In this example, the cache 300 is a set-associative cache. The cache 300 includes a tag array 302 and a data array 304. The data array 304 contains a plurality of last level cache sets 306(0)-306(M), where ‘M+1’ is equal to the number of last level cache sets 306(0)-306(M). As one example, 1,024 last level cache sets 306(0)-306(1023) may be provided in the data array 304. Each of the plurality of last level cache sets 306(0)-306(M) is configured to store cache data in one or more last level cache entries 308(0)-308(N), wherein ‘N+1’ is equal to the number of last level cache entries 308(0)-308(N) per last level cache set 306(0)-306(M). A cache controller 310 is also provided in the cache memory system 104. The cache controller 310 is configured to fill system data 312 from a system data entry 318 in the system memory 106 into the data array 304. The received system data 312 is stored as cache data 314 in a last level cache entry 308(0)-308(N) in the data array 304 according to a memory address for the system data 312. In this manner, the CPU 102 can access the cache data 314 stored in the cache 300 as opposed to having to obtain the cache data 314 from the system memory 106.

With continuing reference to FIG. 3, the cache controller 310 is also configured to receive requests 316 from the lower-level cache memory 112. The requests 316 can include a memory access request 316(1) in the event of a cache miss to the lower-level cache memory 112 or an eviction request to evict a lower-level cache entry 320 in the lower-level cache memory 112 into the LLC memory 114. For a memory access request 316(1), the cache controller 310 indexes the tag array 302 in the cache 300 using the memory address of the memory access request 316(1). If the tag stored at an index in the tag array 302 indexed by the memory address matches the memory address in the memory access request 316(1), and the tag is valid, a cache hit occurs. This means that the cache data 314 corresponding to the memory address of the memory access request 316(1) is contained in a last level cache entry 308(0)-308(N) in the data array 304. In response, the cache controller 310 causes the indexed cache data 314 corresponding to the memory address of the memory access request 316(1) to be provided back to the lower-level cache memory 112. If a cache miss occurs, a cache miss is generated as a cache miss/hit indicator 322, and the cache controller 310 forwards the memory access request 316(1) to the system memory 106.

As discussed above, if a cache miss incurred in the lower-level cache memory 112 is serviced by the LLC memory 114, this means that the last level cache entry 308(0)-308(N) in the LLC memory 114 was reused, and thus was not a dead last level cache entry 308(0)-308(N). If however, a cache miss incurred in the lower-level cache memory 112 is serviced instead by the system memory 106, this is an indication that the LLC memory 114 incurred a cache miss, which reduces the performance of the cache memory system 104. Thus, in response to eviction of the lower-level cache entry 320 from the lower-level cache memory 112 in a received lower-level cache miss request 316(2), the cache memory system 104, and more specifically the cache controller 310 in this example, is configured to predict if the received evicted lower-level cache entry 320 will be DOA if installed in the LLC memory 114. In response to determining that the evicted lower-level cache entry 320 is predicted to be dead in the LLC memory 114, the cache controller 310 is configured to filter the evicted lower-level cache entry 320 in the LLC memory 114. As will be discussed in more detail below, in one example, if the evicted lower-level cache entry 320 is predicted to be DOA, the LLC memory 114 could be bypassed where the evicted lower-level cache entry 320 is installed in the system memory 106 to avoid consuming space in the LLC memory 114 for dead cache entries. In other aspects disclosed herein and below, if the evicted lower-level cache entry 320 is predicted to be DOA, the LLC memory 114 is filtered to install the lower-level cache entry 320 in a less recently used last level cache entry 308(0)-308(N) in the data array 304 of the LLC memory 114 to reduce or avoid evicting a more recently used last level cache entry 308(0)-308(N) in the LLC memory 114.

With continuing reference to FIG. 3, in this example, to provide a mechanism to allow the cache controller 310 to predict if an evicted lower-level cache entry 320 is DOA to the LLC memory 114, a DOA prediction circuit 324 is provided in the cache memory system 104. The DOA prediction circuit 324 includes one or more DOA prediction registers 326(0)-326(P) that can be associated with the lower-level cache entry 320. The DOA prediction circuit 324 may be a memory table that has memory bit cells (e.g., static random access memory (SRAM) bit cells) to form each of the DOA prediction registers 326(0)-326(P). As will be discussed in more detail below, as examples, the DOA prediction circuit 324 may be organized so that a memory address of the evicted lower-level cache entry 320 or program counter (PC) of a load instruction that triggered the eviction of the lower-level cache entry 320 is used to index a DOA prediction register 326(0)-326(P) in the DOA prediction circuit 324. Each DOA prediction register 326(0)-326(P) is configured to store a DOA prediction value 328(0)-328(P) indicative of whether a corresponding lower-level cache entry 320 is predicted to be dead from the LLC memory 114.

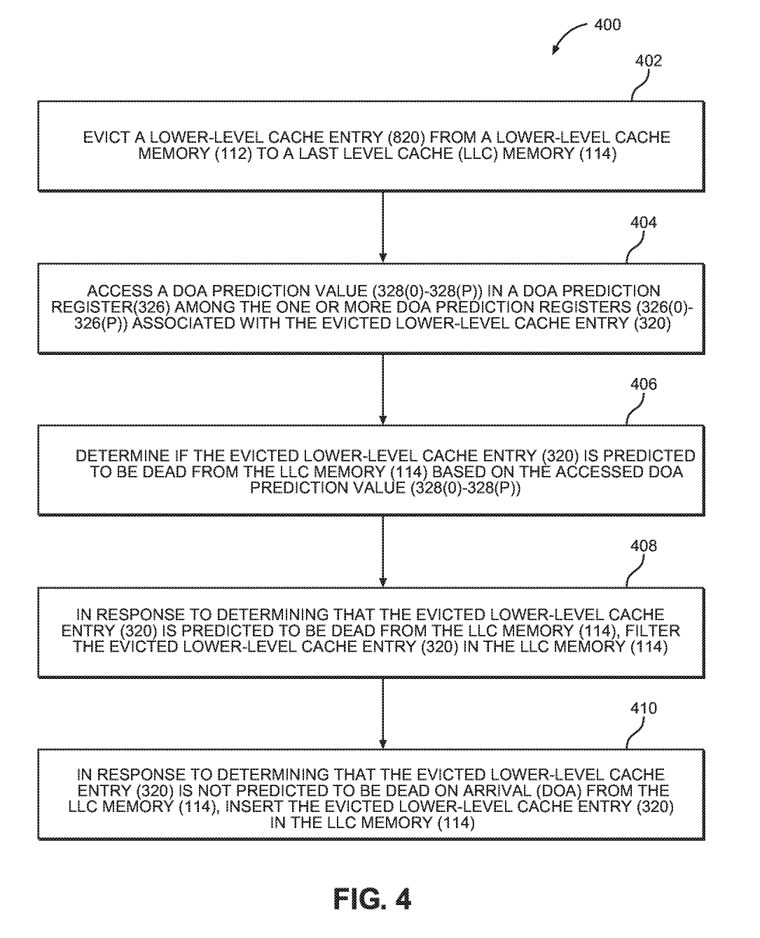

As shown in an exemplary process 400 in FIG. 4 referencing the cache memory system 104 in FIG. 3, the lower-level cache memory 112 is configured to evict a lower-level cache entry 320 from the lower-level cache memory 112 to the LLC memory 114 (block 402). In response, the cache controller 310 is configured to access a DOA prediction value 328(0)-328(P) in a DOA prediction register 326 among the one or more DOA prediction registers 326(0)-326(P) associated with the received evicted lower-level cache entry 320 (block 404). The cache controller 310 is configured to determine if the evicted lower-level cache entry 320 is predicted to be dead from the LLC memory 114 based on the accessed DOA prediction value 328(0)-328(P) associated with the evicted lower-level cache entry 320 (block 406). In response to determining that the evicted lower-level cache entry 320 is predicted to be dead from the LLC memory 114, the cache controller 310 is configured to filter the evicted lower-level cache entry 320 in the LLC memory 114 (block 408). This filtering can include as examples, bypassing the LLC memory 114 to store the evicted lower-level cache entry 320 in the system memory 106, and storing the evicted lower-level cache entry 320 in a less recently used last level cache entry 308(0)-308(N) in the data array 304 of the cache 300. In one example, if the cache controller 310 determines that the evicted lower-level cache entry 320 is predicted to be DOA from the LLC memory 114 based on the accessed DOA prediction value 328(0)-328(P) in the DOA prediction circuit 324, the cache controller 310 will forward the evicted lower-level cache entry 320 to the system memory 106 if the evicted lower-level cache entry 320 is dirty. Otherwise, the cache controller 310 may only silently evict the evicted lower-level cache entry 320 to the system memory 106. However, if the cache controller 310 determines that the evicted lower-level cache entry 320 is predicted to not be DOA from the LLC memory 114 based on the accessed DOA prediction value 328(0)-328(P) in the DOA prediction circuit 324, the cache controller 310 inserts the evicted lower-level cache entry 320 into the cache 300 of the LLC memory 114 (block 410).

In the example of the cache memory system 104 in FIG. 3, the DOA prediction circuit 324 in the cache memory system 104 is provided as a separate circuit apart from the LLC memory 114. This is because the DOA prediction circuit 324 contains a reuse history of the last-level cache entries 308(0)-308(N) in the LLC memory 114 through use of the DOA prediction values 328(0)-328(P) stored in the respective DOA prediction registers 326(0)-326(P). If the DOA prediction values 328(0)-328(P) were stored in the cache 300 of the LLC memory 114 along with the last level cache entries 308(0)-308(N), the reuse history of a last level cache entry 308(0)-308(N) would be lost from the LLC memory 114 when the last level cache entry 308(0)-308(N) is evicted and the last level cache entry 308(0)-308(N) is overwritten. The DOA prediction circuit 324 can be provided in the LLC memory 114 outside of the tag array 302 and the data array 304. The DOA prediction circuit 324 can also be provided outside of the LLC memory 114.

As discussed above, the DOA prediction circuit 324 is accessed by the cache controller 310 to predict if an evicted lower-level cache entry 320 will be dead in the LLC memory 114. However, the DOA prediction circuit 324 is also updated to store the reuse history in the LLC memory 114 associated with the evicted lower-level cache entry 320. In this regard, the cache memory system 104 is configured to establish and update the DOA prediction values 328(0)-328(P) in the DOA prediction registers 326(0)-326(P) when cache misses occur in the lower-level cache memory 112 and are sent as lower-level cache miss requests 316(2) to the LLC memory 114. This is because as previously discussed, if the lower-level cache miss request 316(2) results in a cache hit in the LLC memory 114, this means that the LLC memory 114 was able to service the cache miss in the lower-level cache memory 112. Thus, the last-level cache entry 308(0)-308(N) corresponding to the servicing of the lower-level cache miss request 316(2) was reused.

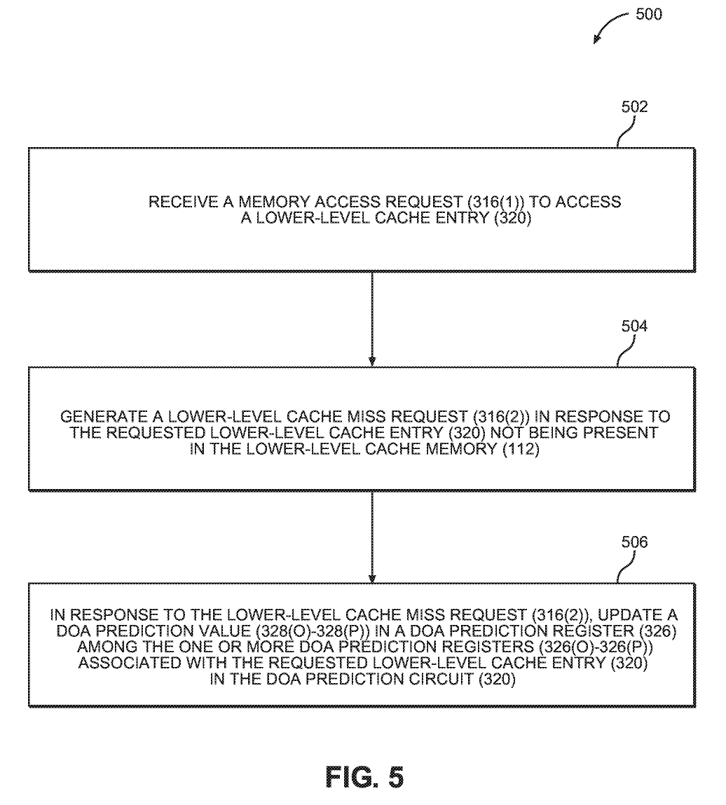

In this regard, FIG. 5 is a flowchart illustrating an exemplary process 500 of updating a DOA prediction value 328(0)-328(P) associated with a lower-level cache miss request 316(2) for a lower-level cache entry 320 in the DOA prediction circuit 324 in FIG. 3. In this regard, the lower-level cache memory 112 receives a memory access request 316(1) to access a lower-level cache entry 320 (block 502). If the lower-level cache entry 320 associated with the memory access request 316(1) is not present in the lower-level cache memory 112, a lower-level cache miss request 316(2) is generated by the lower-level cache memory 112 to the LLC memory 114 (block 504). The DOA prediction value 328(0)-328(P) in the DOA prediction register 326(0)-326(P) in the DOA prediction circuit 324 corresponding to the lower-level cache entry 320 corresponding to the lower-level cache miss request 316(2) can be updated to indicate this reuse occurrence. In this regard, in response to the lower-level cache miss request 316(2), the lower-level cache memory 112 in this example is configured to update a DOA prediction value 328(0)-328(P) in a DOA prediction register 326 among the DOA prediction registers 326(0)-326(P) associated with the requested lower-level cache entry 320 in the DOA prediction circuit 324 (block 506).

If the lower-level cache miss request 316(2) results in a cache miss in the LLC memory 114, this means that the lower-level cache entry 320 was not able to be serviced by the LLC memory 114 and instead is serviced by the system memory 106 meaning the lower-level cache entry 320 corresponding to the lower-level cache miss request 316(2) was evicted from the LLC memory 114 before it could be reused. The DOA prediction value 328(0)-328(P) in the DOA prediction register 326(0)-326(P) in the DOA prediction circuit 324 corresponding to the lower-level cache entry 320 corresponding to the lower-level cache miss request 316(2) can be updated to indicate this non-reuse occurrence. If however, the lower-level cache miss request 316(2) results in a cache hit in the LLC memory 114, this means that the lower-level cache entry 320 was able to be serviced by the LLC memory 114, meaning the lower-level cache entry 320 corresponding to the lower-level cache miss request 316(2) was not evicted from the LLC memory 114 before it could be reused. The DOA prediction value 328(0)-328(P) in the DOA prediction register 326(0)-326(P) in the DOA prediction circuit 324 corresponding to the lower-level cache entry 320 corresponding to the lower-level cache miss request 316(2) can be updated to indicate this reuse occurrence in the LLC memory 114. As discussed above, the cache controller 310 in the LLC memory 114 for example can access this reuse history in the DOA prediction circuit 324 in response to an evicted lower-level cache entry 320 received as a lower-level cache miss request 316(2) in the LLC memory 114.

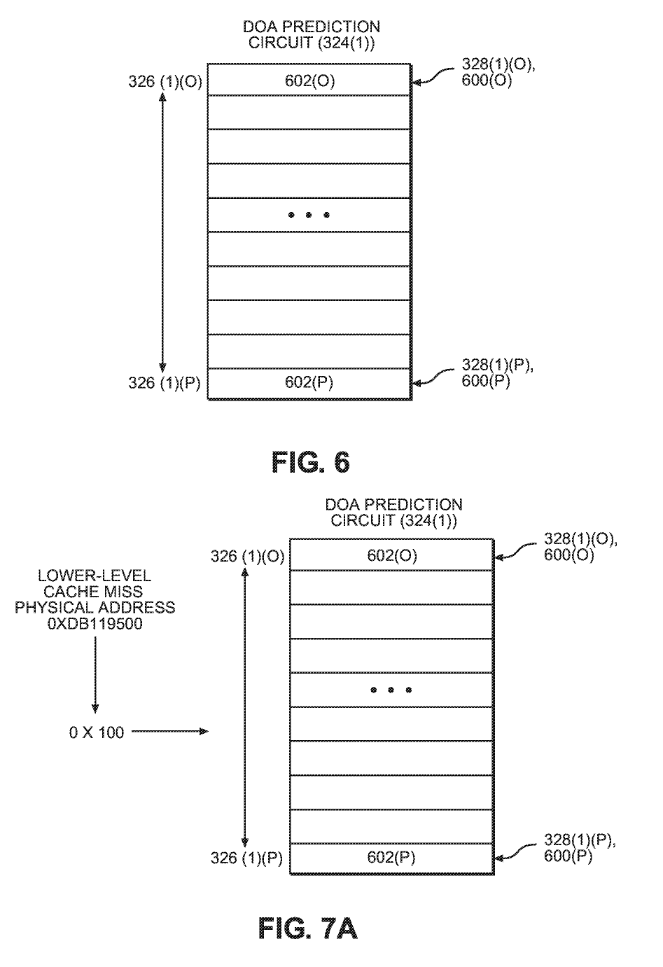

The DOA prediction circuit 324 in the cache memory system 104 in FIG. 3 can be provided in different circuits and in different architectures depending on how the reuse history of the evicted lower-level cache entry 320 in the LLC memory 114 is designed to be tracked and updated. For example, FIG. 6 illustrates an exemplary DOA prediction circuit 324(1) that can be employed as the DOA prediction circuit 324 in the cache memory system 104 in FIG. 3. The DOA prediction circuit 324(1) includes a plurality of DOA prediction registers 326(1)(0)-326(1)(P) that may be DOA prediction counters 600(0)-600(P) each configured to store a DOA prediction count 602(0)-602(P) as DOA prediction values 328(1)(0)-328(1)(P). The DOA prediction count 602(0)-602(P) can be used by the cache memory system 104 in FIG. 3, and the cache controller 310 in one example, to predict if the evicted lower-level cache entry 320 will be dead in the LLC memory 114.

For example, the evicted lower-level cache entry 320 may be predicted to be dead if the accessed DOA prediction count 602(0)-602(P) in the DOA prediction circuit 324(1) exceeds a predefined prediction count value. For example, when a DOA prediction count 602(0)-602(P) for a lower-level cache entry 320 is first established in the DOA prediction circuit 324(1) in response to a cache miss in the lower-level cache memory 112, the initial DOA prediction count 602(0)-602(P) may be set to a saturation level (e.g., 355 if the DOA prediction register 326(1)(0)-326(1)(P) is eight (8) bits long). Then, upon receipt of the lower-level cache miss request 316(2) from the lower-level cache memory 112, if a cache miss for the lower-level cache miss request 316(2) also occurs in the LLC memory 114 such that the lower-level cache miss request 316(2) was serviced by the system memory 106, the DOA prediction count 602(0)-602(P) in the DOA prediction register 326(1)(0)-326(1)(P) corresponding to the lower-level cache miss request 316(2) may be decremented. On the other hand, if the cache miss was a hit in the LLC memory 114 and thus serviced by the LLC memory 114, the DOA prediction count 602(0)-602(P) in the DOA prediction register 326(1)(0)-326(1)(P) corresponding to the lower-level cache miss request 316(2) may be incremented unless saturated. Exceeding the predefined prediction count value may include the DOA prediction count 602(0)-602(P) in the DOA prediction register 326(1)(0)-326(1)(P) corresponding to the lower-level cache miss request 316(2) below a defined DOA prediction count 602(0)-602(P) in this example since the DOA prediction count 602(0)-602(P) is being decremented in response to a cache miss to the LLC memory 114.

Alternatively, as another example, the initial DOA prediction count 602(0)-602(P) may be set to its lowest count value (e.g., 0), wherein the DOA prediction count 602(0)-602(P) in the DOA prediction register 326(1)(0)-326(1)(P) corresponding to the lower-level cache miss request 316(2) is incremented when the lower-level cache miss request 316(2) is serviced by the system memory 106, and then decremented when the lower-level cache miss request 316(2) is serviced by the LLC memory 114. In this case, exceeding the predefined prediction count value may include the DOA prediction count 602(0)-602(P) in the DOA prediction register 326(1)(0)-326(1)(P) corresponding to the lower-level cache miss request 316(2) below above a defined DOA prediction count 602(0)-602(P).

The predefined prediction count value to which an accessed DOA prediction count 602(0)-602(P) in the DOA prediction circuit 324(1) is compared can be adjusted as desired. For example, the predefined prediction count value may be set so that the LLC memory 114 is not always filtered due to the LLC memory 114 being initially empty of lower-level cache entries 308(0)-308(N). For example, if the LLC memory 114 is initially empty after a system start or reset of the processor system 100 in FIG. 1 and/or a reset of the cache memory system 104 as examples, the memory access requests to the lower-level cache memory 112 will be serviced by the system memory 106. Thus, if the predefined prediction count value was such that evicted lower-level cache entries 320 from the lower-level cache memory 112 were initially predicted as DOA, they will always be predicted as DOA. This is because the prediction of the lower-level cache entries 320 from the lower-level cache memory 112 as DOA will filter out the LLC memory 114, and thus the LLC memory 114 will never get filled. However, if the predefined prediction count value was set such that initially evicted lower-level cache entries 320 from the lower-level cache memory 112 were not initially predicted as DOA, the LLC memory 114 will not get filtered out and will eventually fill up. Thereafter, the DOA prediction counts 602(0)-602(P) in the DOA prediction circuit 324(1) will be updated, such as described above, to be used for a DOA prediction of future evicted lower-level cache entries 320 from the lower-level cache memory 112.

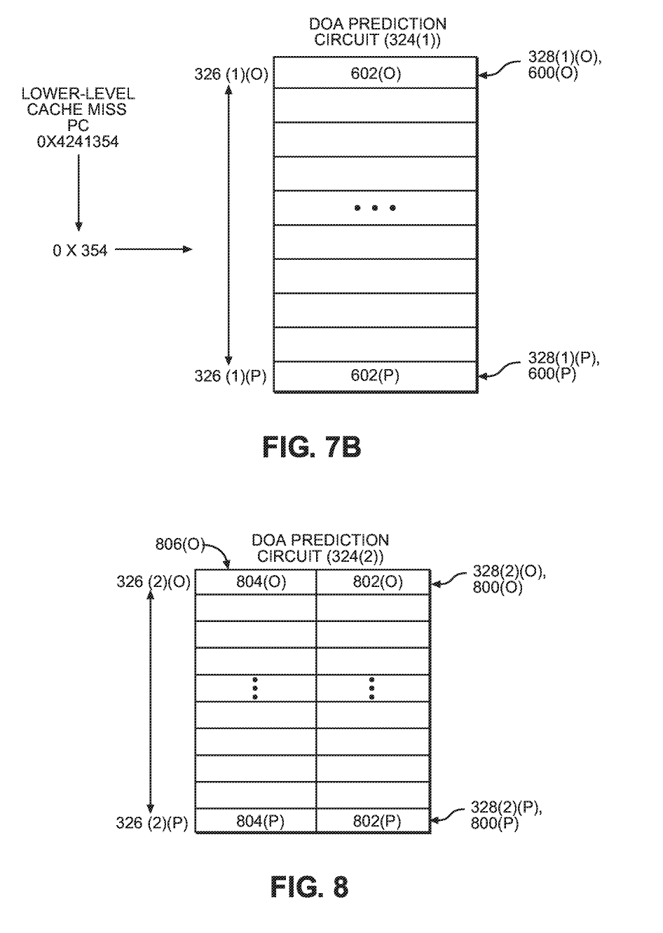

The DOA prediction circuit 324(1) can be configured to be accessed in different ways in response to the lower-level cache miss request 316(2). For example, as shown in FIG. 7A, the DOA prediction circuit 324(1) may be configured to be accessed based on a physical memory address of the lower-level cache miss request 316(2). In this regard, the DOA prediction registers 326(1)(0)-326(1)(P) are associated with physical memory addresses. For example, if the DOA prediction circuit 324(1) contains 1034 DOA prediction registers 326(1)(0)-326(1)(P), wherein ‘P’ equals 1033, the physical memory address of the lower-level cache miss request 316(2) (e.g., 0xDB119500) can be truncated or hashed to 10-bits to index a DOA prediction register 326(1)(0)-326(1)(P) in the DOA prediction circuit 324(1). For example, the ten (10) least significant bits (LSBs) of the physical memory address (e.g., 0x100 10-bit LSB of physical memory address of 0xDB119500) may be used to index a DOA prediction register 326(1)(0)-326(1)(P) in the DOA prediction circuit 324(1). As another example as shown in FIG. 7B, the DOA prediction circuit 324(1) may be configured to be accessed based on the program counter (PC) of a load instruction that issued the data request that caused the lower-level cache miss request 316(2) to be generated by the lower-level cache memory 112. In this example, the DOA prediction registers 326(1)(0)-326(1)(P) are associated with PCs. For example, if the DOA prediction circuit 324(1) contains 1034 DOA prediction registers 326(1)(0)-326(1)(P), wherein ‘P’ equals 1033, the PC corresponding to the lower-level cache miss request 316(2) (e.g., 0x4045B4) can be truncated to 10-bits to index a DOA prediction registers 326(1)(0)-326(1)(P) in the DOA prediction circuit 324(1). For example, the ten (10) least significant bits (LSBs) of the PC (e.g., 10-bit LSB 0x354 of PC of 0x404B54) may be used to index a DOA prediction register 326(1)(0)-326(1)(P) in the DOA prediction circuit 324(1).

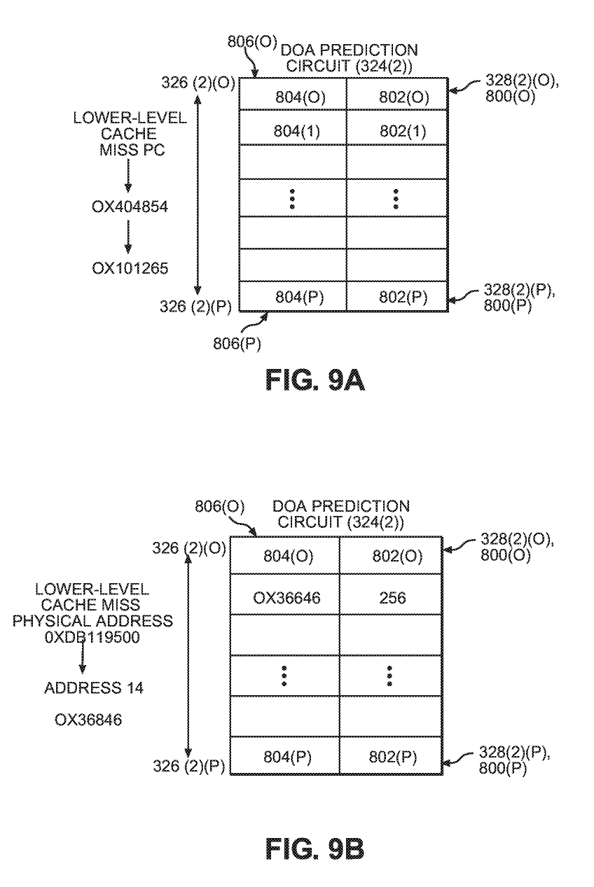

FIG. 8 illustrates another exemplary tagged DOA prediction circuit 324(2) that can be employed as the DOA prediction circuit 324 in the cache memory system 104 in FIG. 3. The DOA prediction circuit 324(2) includes a plurality of DOA prediction registers 326(2)(0)-326(2)(P) that may be DOA prediction counters 800(0)-800(P) each configured to store a DOA prediction count 802(0)-802(P) as DOA prediction values 328(2)(0)-328(2)(P). The DOA prediction count 802(0)-802(P) can be used by the cache memory system 104 in FIG. 3, and the cache controller 310 in one example, to predict if the evicted lower-level cache entry 320 will be dead in the LLC memory 114. The DOA prediction circuit 324(2) is configured to be accessed based on tags 804(0)-804(P) stored in respective DOA prediction tags 806(0)-806(P) associated with each DOA prediction counter 800(0)-800(P). For example, as shown in FIG. 9A, the DOA prediction circuit 324(2) may be configured to be accessed based on the physical memory address of the lower-level cache miss request 316(2) from the lower-level cache memory 112 in FIG. 3. For example, the physical memory address of the lower-level cache miss request 316(2) (e.g., 0xDB119500) can be shifted by a defined number of bits (e.g., by 14-bits to 0x36846) to form a tag to compare to a tag 804(0)-804(P) stored in the DOA prediction circuit 324(2). For example, the DOA prediction circuit 324(2) may contain 3¹⁸ (i.e., 356K) DOA prediction registers 326(2)(0)-326(2)(P), wherein ‘P’ equals 3¹⁸−1. If a tag formed based on the physical memory address of the lower-level cache miss request 316(2) matches a tag 804(0)-804(P) stored in the DOA prediction circuit 324(2), the DOA prediction counter 800(0)-800(P) associated with the matching tag 804(0)-804(P) is used to access a DOA prediction count 802(0)-802(P) for predicting an evicted lower-level cache entries 320 that is DOA, and for updating a DOA prediction count 802(0)-802(P) associated with a lower-level cache miss request 316(2) for the lower-level cache entry 320.

As another example as shown in FIG. 9B, the DOA prediction circuit 324(2) may be configured to be accessed based on the program counter (PC) of a load instruction that issued the data request that caused the lower-level cache miss request 316(2) to be generated by the lower-level cache memory 112. For example, the PC associated with the lower-level cache miss request 316(2) (e.g., 0x404B54) can be shifted by a defined number of bits (e.g., by 3-bits to 0x1013B5) to form a tag to compare to a tag 804(0)-804(P) stored in the DOA prediction circuit 324(2). For example, the DOA prediction circuit 324(2) may contain 3¹⁸ (i.e., 356K) DOA prediction registers 326(2)(0)-326(2)(P), wherein ‘P’ equals 3¹⁸−1. If a tag formed based on the PC associated with the lower-level cache miss request 316(2) matches a tag 804(0)-804(P) stored in the DOA prediction circuit 324(2), the DOA prediction counter 800(0)-800(P) associated with the matching tag 804(0)-804(P) is used to access a DOA prediction count 802(0)-802(P) for predicting an evicted lower-level cache entry 320 that is DOA, and for updating a DOA prediction count 802(0)-802(P) associated with a lower-level cache miss request 316(2) for the lower-level cache entry 320.

As discussed previously, with reference back to the processor system 100 in FIG. 3, it is also possible that instead of bypassing insertion of an evicted lower-level cache entry 320 predicted to be DOA in the LLC memory 114 in FIG. 3, an evicted lower-level cache entry 320 predicted to be DOA, including according to any of the DOA prediction examples discussed above, can still be inserted in the LLC memory 114. However, in this example, it may be advantageous to filter such evicted lower-level cache entries 320 predicted to be DOA to be inserted in less recently used last level cache entries 308(0)-308(P) in the data array 304 of the cache 300 of the LLC memory 114. The cache controller 310 is configured to track and determine the usage of the last level cache entries 308(0)-308(P) to determine which are more recently used and which are less recently used for deciding in which of the last level cache entries 308(0)-308(P) to insert an evicted lower-level cache entry 320 from the lower-level cache memory 112. In this manner, the LLC memory 114 does not have to evict more recently used last level cache entries 308(0)-308(P) to make room for storing the evicted lower-level cache entry 320. More recently used last level cache entries 308(0)-308(P) may have a greater likelihood of being reused than less recently used last level cache entries 308(0)-308(P) for greater efficiency and performance of the LLC memory 114.

Further, while the previous examples discussed above of predicting whether an evicted lower-level cache entry 320 is DOA in the LLC memory 114, the DOA prediction does not necessarily have to be followed in determining whether to filter out the LLC memory 114 or not. For example, the LLC memory 114 may use the DOA prediction for the evicted lower-level cache entry 320 as a hint as to whether to filter out the LLC memory 114 or not rather than an absolute requirement.

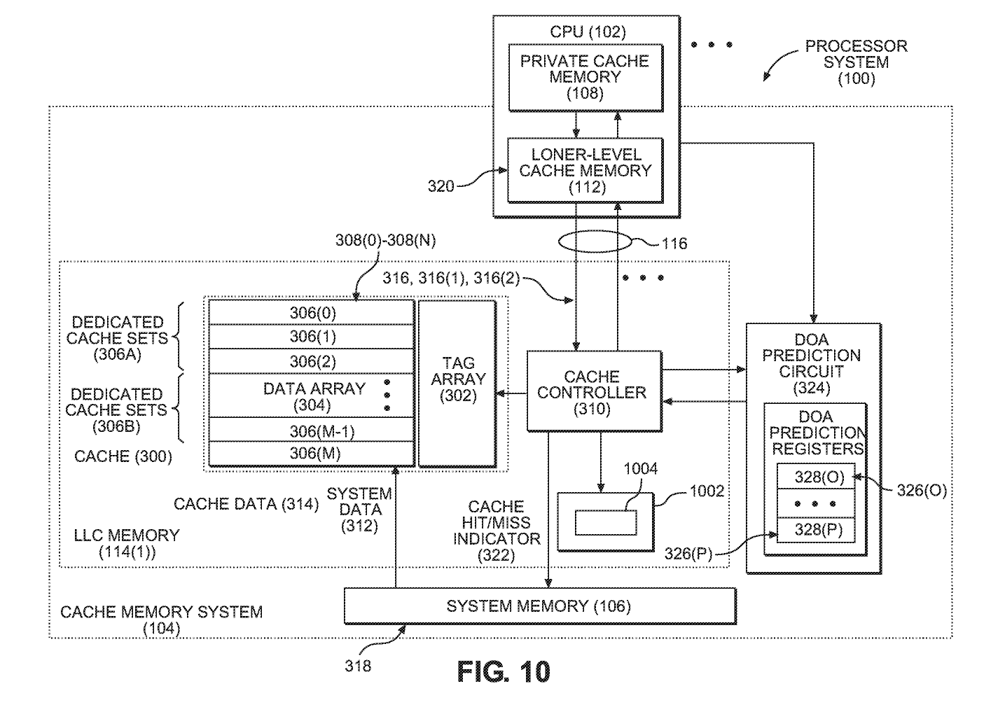

In this regard, FIG. 10 illustrates the processor system 100 in FIG. 3, with an alternative LLC memory 114(1) that employs cache set dueling to determine if the DOA prediction hint for the lower-level cache entry 320 will be followed by the LLC memory 114(1). In other words, in response to the lower-level cache memory 112 indicating that an evicted lower-level cache entry 320 is DOA to the LLC memory 114(1), the LLC memory 114(1) can use cache set dueling to determine if the DOA prediction will be followed. If a DOA prediction of the evicted lower-level cache entry 320 is followed, the LLC memory 114(1) can be bypassed from the LLC memory 114(1) to the system memory 106. If a DOA prediction of the evicted lower-level cache entry 320 is not followed, the evicted lower-level cache entry 320 can be stored in the LLC memory 114(1) and not be bypassed to the system memory 106. Common components are illustrated with common element numbers between FIGS. 3 and 10.

In the cache 300 of the LLC memory 114(1) in FIG. 10, a subset of the last level cache sets 306(0)-306(M) are allocated as being “dedicated” cache sets 306A, 306B. The other last level cache sets 306(0)-306(M) not allocated as dedicated cache sets 306A, 306B are non-dedicated cache sets also known as “follower” cache sets. Each of the dedicated cache sets 306A, 306B has an associated dedicated filter policy for the given dedicated cache set 306A, 306B. The notation ‘A’ designates that a first DOA prediction policy A is used by the cache controller 310 for cache misses into the dedicated cache set 306A. Other last level cache sets 306(0)-306(M) among the last level cache sets 306(0)-306(M) are designated as dedicated cache sets 306B. The notation ‘B’ designates that a second DOA prediction policy B, different from the first DOA prediction policy A, is used by the cache controller 310 for cache hits into the dedicated cache set 306B. For example, the first DOA prediction policy A may be used to bypass the LLC memory 114, and the second DOA prediction policy B may be used to not bypass the LLC memory 114. Cache misses for accesses to each of the dedicated cache sets 306A, 306B in response to a lower-level cache miss request 316(2) from the lower-level cache memory 112 are tracked by the cache controller 310. For example, a cache miss to dedicated cache set 306A may be used to update (e.g., increment or decrement) a DOA prediction value 1002 (e.g., a count) in a DOA prediction register 1004 (e.g., a counter) associated with the lower-level cache miss request 316(2). A cache miss to dedicated cache set 306B may be used to update (e.g., decrement or increment the DOA prediction value 1002 in the DOA prediction register 1004 associated with the lower-level cache miss request 316(2). In other words, the dedicated cache sets 306A, 306B in the data array 304 in FIG. 10 are set in competition with each other, otherwise known as “dueling.” When the LLC memory 114(1) receives an evicted lower-level cache entry 320, the LLC memory 114(1) can consult the DOA prediction register 1004 to determine which policy between the first DOA prediction policy A and the second DOA prediction policy B should be employed based on past cache misses and hits to the dedicated cache sets 306A, 306B. The first DOA prediction policy A to bypass the LLC memory 114(1), or the second DOA prediction policy B to not bypass the LLC memory 114(1) should be employed.

As an example, the DOA prediction register 1004 may be a single up/down cache miss counter that is incremented and decremented based on whether the cache miss accesses a dedicated cache set 306A or dedicated cache set 306B in the LLC memory 114(1).

Cache memory systems that are configured to filter insertion of evicted cache entries predicted as DOA into a last LLC memory of a cache memory system according to aspects disclosed herein, may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

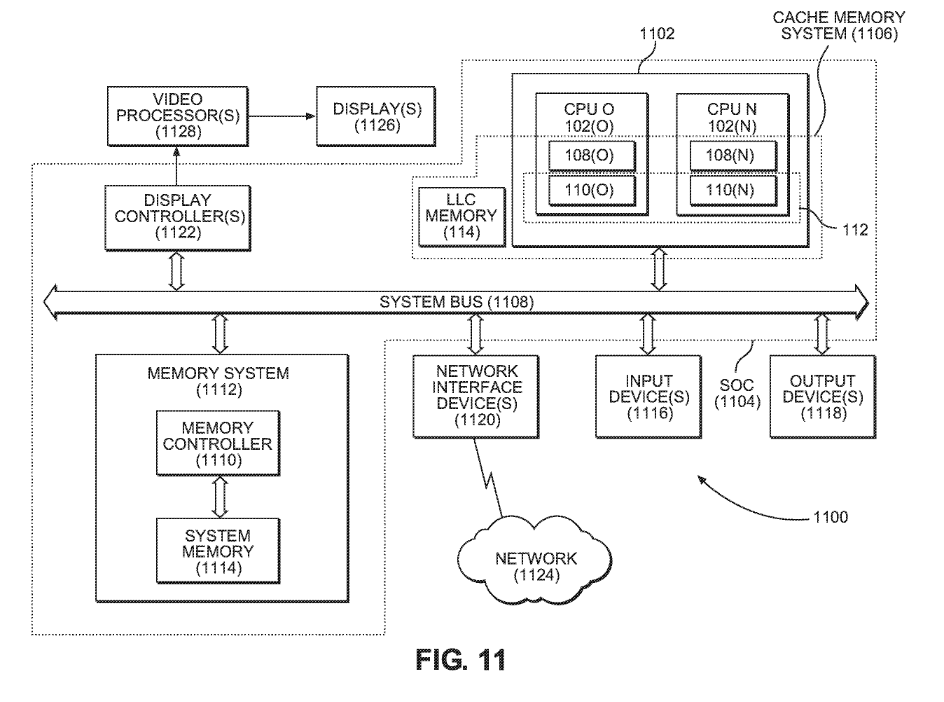

In this regard, FIG. 11 illustrates an example of a processor-based system 1100 configured to filter insertion of evicted cache entries predicted as DOA into an LLC memory, including according to any of the particular aspects discussed above. The processor-based system 1100 includes a processor 1102 that may be the processor system 100 in FIGS. 3 and 10. The processor-based system 1110 may be provided as a system-on-a-chip (SoC) 1104. The processor 1103 includes a cache memory system 1106. For example, the cache memory system 1106 may be the cache memory system 104 in FIG. 3 or 10. In this example, the processor 1103 includes multiple CPUs 102(0)-102(N) in the processor system 100 in FIG. 3 or 10. The CPUs 102(0)-102(N) are coupled to a system bus 1108 and can intercouple peripheral devices included in the processor-based system 1100. Although not illustrated in FIG. 11, multiple system buses 1108 could be provided, wherein each system bus 1108 constitutes a different fabric. As is well known, the CPUs 102(0)-102N) communicates with other devices by exchanging address, control, and data information over the system bus 1108. For example, the CPUs 102(0)-102(N) can communicate bus transaction requests to a memory controller 1110 in a memory system 1112 as an example of a slave device. The memory controller 1110 can be the memory controller 118 in FIG. 3 or 10. In this example, the memory controller 1110 is configured to provide memory access requests to system memory 1114, which may be the system memory 106 in FIGS. 3 and 10.

Other devices can be connected to the system bus 1108. As illustrated in FIG. 11, these devices can include the memory system 1112, one or more input devices 1116, one or more output devices 1118, one or more network interface devices 1120, and one or more display controllers 1122, as examples. The input device(s) 1116 can include any type of input device, including but not limited to input keys, switches, voice processors, etc. The output device(s) 1118 can include any type of output device, including but not limited to audio, video, other visual indicators, etc. The network interface device(s) 1120 can be any devices configured to allow exchange of data to and from a network 1124. The network 1124 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1120 can be configured to support any type of communications protocol desired.

The CPUs 102(0)-102(N) may also be configured to access the display controller(s) 1122 over the system bus 1108 to control information sent to one or more displays 1126. The display controller(s) 1122 sends information to the display(s) 1126 to be displayed via one or more video processors 1128, which process the information to be displayed into a format suitable for the display(s) 1126. The display(s) 1126 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A cache memory system, comprising:
a lower-level cache memory configured to store a plurality of lower-level cache entries each representing a system data entry in a system memory, the lower-level cache memory configured to:
evict a lower-level cache entry among the plurality of lower-level cache entries to a last level cache (LLC) memory; and
receive a last level cache entry from the LLC memory in response to a cache miss to a lower-level cache;
the LLC memory configured to store a plurality of last level cache entries each representing the system data entry in the system memory, the LLC memory configured to:
insert the evicted lower-level cache entry from the lower-level cache memory in a last level cache entry among the plurality of last level cache entries based on an address of the evicted lower-level cache entry;
evict the last level cache entry to the system memory; and
receive the system data entry from the system memory in response to a cache miss to the LLC memory;
a dead-on-arrival (DOA) prediction circuit comprising one or more DOA prediction registers associated with the plurality of lower-level cache entries each configured to store a DOA prediction value indicative of a whether the plurality of lower-level cache entries are predicted to be dead from the LLC memory; and
in response to eviction of the lower-level cache entry from the lower-level cache memory, the cache memory system configured to:
access a DOA prediction value in a DOA prediction register among the one or more DOA prediction registers associated with the evicted lower-level cache entry;
determine if the evicted lower-level cache entry is predicted to be dead from the LLC memory based on the accessed DOA prediction value; and
in response to determining that the evicted lower-level cache entry is predicted to be dead from the LLC memory, filter the evicted lower-level cache entry in the LLC memory.

2. The cache memory system of claim 1, wherein in response to determining the evicted lower-level cache entry is predicted to be dead from the LLC memory, the cache memory system is configured to filter the evicted lower-level cache entry by being configured to not insert the evicted lower-level cache entry into the LLC memory.

3. The cache memory system of claim 1, wherein in response to determining the evicted lower-level cache entry is predicted to be dead from the LLC memory, the cache memory system is configured to filter the evicted lower-level cache entry by being configured to insert the evicted lower-level cache entry into a less recently used cache entry in the LLC memory.

4. The cache memory system of claim 1, further configured to, in response to determining the evicted lower-level cache entry is predicted to be dead from the LLC memory based on the accessed DOA prediction value;
determine if the evicted lower-level cache entry is dirty; and
in response to determining that the evicted lower-level cache entry is dirty, insert the evicted lower-level cache entry into the system memory.

5. The cache memory system of claim 1, further configured to, in response to determining that the evicted lower-level cache entry is not predicted to be dead from the LLC memory, insert the evicted lower-level cache entry in the LLC memory.

6. The cache memory system of claim 1, wherein the DOA prediction circuit is not included in the plurality of last level cache entries of the LLC memory.

7. The cache memory system of claim 1, wherein the one or more DOA prediction registers comprises one or more DOA prediction counters each configured to store the DOA prediction value comprising a DOA prediction count;
wherein the cache memory system is configured to, in response to the eviction of the lower-level cache entry from the lower-level cache memory:
access a DOA prediction count in a DOA prediction counter among the one or more DOA prediction counters associated with the evicted lower-level cache entry; and
determine if the evicted lower-level cache entry is predicted to be dead from the LLC memory based on the accessed DOA prediction count.

8. The cache memory system of claim 7, wherein the cache memory system is configured to, in response to the eviction of the lower-level cache entry from the lower-level cache memory:
determine if the evicted lower-level cache entry is predicted to be dead from the LLC memory based on the accessed DOA prediction count exceeding a predefined prediction count value.

9. The cache memory system of claim 8, wherein the cache memory system is configured to, in response to the eviction of the lower-level cache entry from the lower-level cache memory:
determine if the evicted lower-level cache entry is predicted to be dead from the LLC memory based on the accessed DOA prediction count exceeding below the predefined prediction count value.

10. The cache memory system of claim 1, wherein the one or more DOA prediction registers are each associated with at least one memory address; and
wherein the cache memory system is configured to, in response to the eviction of the lower-level cache entry from the lower-level cache memory, access a DOA prediction value in a DOA prediction register among the one or more DOA prediction registers associated with a memory address of the evicted lower-level cache entry.

11. The cache memory system of claim 10, wherein:
the cache memory system is further configured to, in response to the eviction of the lower-level cache entry from the lower-level cache memory, generate a hash value based on the memory address of the evicted lower-level cache entry; and
the cache memory system is configured to, in response to the eviction of the lower-level cache entry from the lower-level cache memory, access the DOA prediction value in the DOA prediction register among the one or more DOA prediction registers based on the hash value of the memory address of the evicted lower-level cache entry.

12. The cache memory system of claim 1, wherein the one or more DOA prediction registers are each associated with at least one memory address;
wherein the cache memory system is configured to, in response to the eviction of the lower-level cache entry from the lower-level cache memory:
access a DOA prediction value in a DOA prediction register among the one or more DOA prediction registers associated with a program counter of a load instruction that generated the evicted lower-level cache entry.

13. The cache memory system of claim 1, wherein the DOA prediction circuit further comprises one or more DOA prediction tags each associated with a DOA prediction register among the one or more DOA prediction registers;
wherein the cache memory system is configured to, in response to the eviction of the lower-level cache entry from the lower-level cache memory, access the DOA prediction value by being configured to:
access a DOA prediction tag among the one or more DOA prediction tags associated with the evicted lower-level cache entry; and
access the DOA prediction value in the DOA prediction register among the one or more DOA prediction registers associated with the accessed DOA prediction tag.

14. The cache memory system of claim 1, wherein:
the lower-level cache memory is configured to:
receive a request to access a lower-level cache entry among the plurality of lower-level cache entries; and
generate a lower-level cache miss in response to the requested lower-level cache entry not being present in the lower-level cache memory; and
in response to the lower-level cache miss, the cache memory system is further configured to update a DOA prediction value in a DOA prediction register among the one or more DOA prediction registers associated with the requested lower-level cache entry in the DOA prediction circuit.

15. The cache memory system of claim 14, wherein in response to the lower-level cache miss, the cache memory system is further configured to determine if a received data entry associated with a memory address of the requested lower-level cache entry was serviced by the system memory; and
wherein the cache memory system is configured to update the DOA prediction value in the DOA prediction register among the one or more DOA prediction registers associated with the requested lower-level cache entry based on the determination of whether the received data entry was serviced by the system memory.

16. The cache memory system of claim 15, wherein the one or more DOA prediction registers comprises one or more DOA prediction counters each configured to store the DOA prediction value comprising a DOA prediction count; and
wherein the cache memory system is configured to update the DOA prediction count in DOA prediction counter among the one or more DOA prediction counters associated with the requested lower-level cache entry if the received data entry was serviced by the system memory.

17. The cache memory system of claim 16, wherein, in response to a first instance of the lower-level cache miss in the lower-level cache memory, the cache memory system is configured to initialize the DOA prediction count in the DOA prediction counter among the one or more DOA prediction counters associated with the requested lower-level cache entry with a saturation count.

18. The cache memory system of claim 1, wherein:
the LLC memory comprises:
an LLC cache comprising a plurality of cache sets comprising a plurality of follower cache sets and a plurality of dedicated cache sets comprising at least one first dedicated cache set comprising a first dedicated subset of the plurality of dedicated cache sets in the LLC cache for which at least one first DOA prediction policy is applied, and at least one second dedicated cache set comprising a second dedicated subset of the plurality of dedicated cache sets in the LLC cache for which at least one second DOA prediction policy, different from the at least one first DOA prediction policy, is applied;
the LLC memory configured to update a DOA prediction value in a DOA prediction register based on a cache miss resulting from an accessed cache entry only in a dedicated cache set among the plurality of dedicated cache sets in the LLC cache;
the lower-level cache memory configured to:
access the DOA prediction value in the DOA prediction register associated with the evicted lower-level cache entry;
determine if the evicted lower-level cache entry is predicted to be dead from the LLC memory based on the accessed DOA prediction value; and
in response to determining that the evicted lower-level cache entry is predicted to be dead from the LLC memory, communicate a DOA prediction for the evicted lower-level cache entry to the LLC memory; and
the LLC memory is further configured to:
access a DOA prediction value in the DOA prediction register;
determine whether the at least one first DOA prediction policy or the at least one second DOA prediction policy should be applied to the evicted lower-level cache entry based on the accessed DOA prediction value; and
filter the evicted lower-level cache entry in the LLC memory based on the determined DOA prediction policy among the at least one first DOA prediction policy and the at least one second DOA prediction policy.

19. The cache memory system of claim 1, wherein the plurality of last level cache entries stored in the LLC memory are exclusive of the plurality of lower-level cache entries stored in the lower-level cache memory.

20. The cache memory system of claim 1, wherein the plurality of last level cache entries stored in the LLC memory are inclusive of the plurality of lower-level cache entries stored in the lower-level cache memory.

21. The cache memory system of claim 1 integrated into a system-on-a-chip (SoC).

22. The cache memory system of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

23. A method of evicting a lower-level cache entry in a cache memory system, comprising:
evicting a lower-level cache entry among a plurality of lower-level cache entries from a lower-level cache memory to a last level cache (LLC) memory;
accessing a dead-on-arrival (DOA) prediction value in a DOA prediction register among one or more DOA prediction registers associated with the evicted lower-level cache entry;
determining if the evicted lower-level cache entry is predicted to be dead from the LLC memory based on the accessed DOA prediction value; and
in response to determining that the evicted lower-level cache entry is predicted to be dead from the LLC memory, filtering the evicted lower-level cache entry in the LLC memory.

24. The method of claim 23, wherein filtering the lower-level cache entry comprises not inserting the evicted lower-level cache entry into the LLC memory.

25. The method of claim 23, wherein filtering the lower-level cache entry comprises inserting the evicted lower-level cache entry into a less recently used cache entry in the LLC memory.

26. The method of claim 23, wherein, in response to determining the evicted lower-level cache entry is not predicted to be dead from the LLC memory, inserting the evicted lower-level cache entry in the LLC memory.

27. A last level cache (LLC) memory, comprising:
a last level cache configured to store a plurality of last level cache entries each representing a data entry in a system memory; and
an LLC controller configured to:
receive an evicted lower-level cache entry from a lower-level cache memory;
insert the received evicted lower-level cache entry in a last level cache entry among the plurality of last level cache entries based on an address of the evicted lower-level cache entry;
evict a last level cache entry among the plurality of last level cache entries to system memory;
receive a system data entry from the system memory in response to a cache miss to the LLC memory; and
in response to the received evicted lower-level cache entry from the lower-level cache memory:
access a dead-on-arrival (DOA) prediction value in a DOA prediction register among one or more DOA prediction registers associated with the evicted lower-level cache entry;
determine if the evicted lower-level cache entry is predicted to be dead from the LLC memory based on the accessed DOA prediction value; and
in response to determining that the evicted lower-level cache entry is predicted to be dead from the LLC memory, filter the evicted lower-level cache entry in the lower-level cache among the plurality of lower-level cache entries.

28. The LLC memory of claim 27, wherein the LLC controller is further configured to, in response to determining that the evicted lower-level cache entry is predicted to be dead from the LLC memory based on the accessed DOA prediction value;
determine if the evicted lower-level cache entry is dirty; and
in response to determining that the evicted lower-level cache entry is dirty, insert the evicted lower-level cache entry into the system memory.

29. The LLC memory of claim 27, wherein the LLC controller is further configured to, in response to determining that the evicted lower-level cache entry is not predicted to be dead from the LLC memory, insert the evicted lower-level cache entry to the LLC memory.

30. A lower-level cache memory, comprising:
a plurality of lower-level cache entries each representing a system data entry in a system memory; and
the lower-level cache memory configured to:
evict a lower-level cache entry among the plurality of lower-level cache entries to a last level cache (LLC) memory;
receive a last level cache entry from the LLC memory in response to a cache miss to the lower-level cache;
receive a request to access the lower-level cache entry among the plurality of lower-level cache entries in the lower-level cache;
generate a lower-level cache miss in response to the requested lower-level cache entry not being present in the lower-level cache; and
in response to the lower-level cache miss:
determine if a received data entry associated with a memory address of the requested lower-level cache entry was serviced by the system memory; and
update a dead-on-arrival (DOA) prediction value in a DOA prediction register among one or more DOA prediction registers associated with the requested lower-level cache entry based on the determination of whether the received data entry was serviced by the system memory.

31. The lower-level cache memory of claim 30, wherein the one or more DOA prediction registers comprises one or more DOA prediction counters each configured to store the DOA prediction value comprising a DOA prediction count; and
wherein the lower-level cache memory is configured to update the DOA prediction count in a DOA prediction counter among the one or more DOA prediction counters associated with the requested lower-level cache entry if the received data entry was serviced by the system memory.
